(19) United States
(12) Patent Application Publication
(10) Pub. No.: US 2026/0229098 A1
(43) Pub. Date: Aug. 6, 2026

(54) TACTILE-ENHANCED DISPLAY

(71) Applicant: The Regents of the University of California, Oakland, CA (US)

(72) Inventors: Iman Soltani Bozchalooi, Sacramento, CA (US); Parisa Emami-Naeini, Sacramento, CA (US); Jonathon S. Schofield, Davis, CA (US); Mehran Madani, Fair Oaks, CA (US); Shuhao Wan, Davis, CA (US)

(73) Assignee: The Regents of the University of California, Oakland, CA (US)

(21) Appl. No.: 19/159,942

(22) PCT Filed: Feb. 27, 2024
(86) PCT No.: PCT/US2024/017471

§ 371 Date: Aug. 26, 2025

Related U.S. Application Data
(60) Provisional application No. 63/487,187, filed on Feb. 27, 2023.

(51) Int. Cl. G08B 6/00; A61H 3/06

(52) U.S. Cl. CPC G08B 6/00; A61H 3/061; A61H 2003/063; A61H 2201/1207; A61H 2201/5043

(57) ABSTRACT

An apparatus, system, and method provide a tactile-enhanced representation of a physical environment, for use by a visually impaired person. The apparatus may be implemented as a cover or accessory for a portable electronic device that features one or more sensors for sensing the environment (e.g., IMU, GPS, LiDAR). The system receives data from the sensor(s), maps it to a surface of the apparatus and activates components of the apparatus to raise or lower corresponding points or regions of the apparatus to represent an obstacle detected in the environment. The components may include an array of magnetic and/or electric actuators that, when instructed, actuate corresponding mechanisms (e.g., mechanical flexures) to raise the points/regions of the surface of the apparatus accordingly.

### RELATED APPLICATION(S)

This application claims the benefit of U.S. Provisional Patent Application No. 63/487,187, filed 27 Feb. 2023 (docket number UC23-524-1PSP), the contents of which are incorporated by reference herein.

### BACKGROUND

This disclosure relates to the field of mechatronics. More specifically, what is provided is a haptic interface compatible with a portable display, such as the display of a smart phone or tablet computer. The interface assists visually impaired individuals with navigating their environment (e.g., when walking) and/or presents them with tactile representations of visual content.

In the United States, nearly 3% of all children younger than 18 are blind or visually impaired, meaning they have trouble seeing even with corrective lenses. It is estimated that over 12 million adults in the United States are also visually impaired, and the estimated economic impact of visual impairment is $145 billion annually. In addition, blindness around the world is anticipated to triple by the year 2050, increasing from 36 to 115 million.

Despite technological advances, in unknown and dynamic environments the visually impaired still use white canes and service dogs as the most reliable navigation tools. Although effective, these tools encumber independent wayfinding and do not convey the rich amount of visuospatial information in the immediate surroundings of visually impaired users. Extensive research efforts have led to a variety of gadgetry, such as chest-mounted cameras and vibratory wristbands; wearable smart glasses; and even a modern white cane equipped with color 3D camera, inertial measurement sensors and onboard data processing. However, translation of these efforts into functional equipment outside the laboratory remains minimal, and there has been limited to no acceptance of such technology among the visually impaired. Previous efforts have met with limited success because:
1) Visually impaired individuals want to live life much like everyone else. While wearable haptics and chest-mounted cameras with auditory feedback may perform well in the laboratory, they require a person to carry additional gadgetry, take time to put on, and adversely impact comfort. This is a stark departure from the experience of sighted individuals who simply grab their cell phones and head out the door.
2) Multi-modality is crucial. Assistive technologies should be lightweight and multi-modal. Wide adoption of smart phones among the visually impaired is a testament to this requirement. It provides them with means for communication, work, entertainment, education, etc.
3) Sense of hearing should not be overburdened. Visually impaired individuals heavily rely upon their sense of hearing and are exceptionally skilled at identifying the direction and source of various sounds (e.g., cars, sirens), other pedestrians, etc. As such, it is important for a navigation tool not to overburden this sense.
4) Involuntary feedback through devices attached to one's body is inconvenient, distracting and may require extensive training to be sufficiently valuable to the user. Involuntary tactile feedback applied to the body, as is done in many prior works (e.g., using vibration), may act as a source of distraction.

Therefore, what is needed is a novel outdoor navigation assistive approach that is reflective of the needs of the visually impaired.

### SUMMARY

In some embodiments, a tactile or haptic interface is provided that can be used as an accessory to a smart device (e.g., as a full or partial cover for a smart phone). The interface features a variable and controllable surface topography to produce a real-time tactile representation of the surrounding environment and thereby guide a visually impaired user in navigating that environment, whether indoor or outdoor.

More particularly, in these embodiments, one or more surfaces of the interface dynamically and automatically morph to reflect the real-world topography surrounding the user, including nearby obstacles. For example, the interface may feature a set of risers that can be individually and/or collectively adjusted to multiple different altitudes above and/or below a surface of the interface. As the user moves about in his or her environment, the risers adjust to depict protruding obstacles (e.g., lamp posts, fire hydrants, cars) and receding obstacles (e.g., potholes, open manholes). The risers thus present a tactile grid pattern that is different from Braille in several aspects, but that can be read in a similar fashion.

The tactile display may be updated with any desirable regularity. For example, it may be updated each time the user moves a threshold distance (e.g., one foot, five feet, ten feet) from a previous position, may be updated based on the passage of time (e.g., five seconds, ten seconds), may be updated only when the user's immediate environment changes, and/or may be updated in response to some other stimulus (e.g., when the user activates a ‘refresh’ control). In addition, the display may recreate any portion of the user's environment, such as an area of an approximate size (e.g., 50ft², 100 ft²), including in front of, to the sides of, and/or behind the user.

In some embodiments, the haptic technology operates on a printed circuit board (PCB)-based electric or magnetic actuator array that drives mechanical flexures via lift bars, springs, threads and pulleys, and/or other means. In contrast to existing technologies for refreshable Braille, a haptic display device has a small footprint and low manufacturing cost. The size of the interface may be dramatically reduced through mechanical multiplexing and use of only a small number of actuators. For example, instead of having a separate actuator or motor for each riser, each actuator may drive a mechanism that can adjust multiple risers. In some implementations, a haptic display interface is at least partially produced via additive manufacturing.

### DESCRIPTION OF THE FIGURES

FIGS. 1A-B illustrate a mechanically multiplexed haptic display (MMHD), according to some embodiments.

FIGS. 2A-B further illustrate a haptic display, according to some embodiments.

FIG. 3A illustrates a single lift bar with associated haptic dots, according to some embodiments.

FIG. 3B illustrates an array of haptic dots connected to multiple lift bars via springs, according to some embodiments.

FIG. 3C illustrates a set of latches for locking associated haptic dots, according to some embodiments.

FIG. 4 is a flowchart illustrating a method of operating a haptic display, according to some embodiments.

FIG. 5 illustrates an alternative apparatus for adjusting haptic dots of a tactile-enhanced display with linear piezo actuators, according to some embodiments.

FIG. 6 illustrates an alternative apparatus for adjusting haptic dots of a tactile-enhanced display with a linear actuator and filament, according to some embodiments.

FIG. 7 illustrates an alternative apparatus for adjusting haptic dots of a tactile-enhanced display with a rotational actuator and filaments, according to some embodiments.

### DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a dynamic topographical haptic display is provided. The haptic display utilizes available sensors (e.g., embedded sensors in a smart phone or other portable electronic device) to identify a user's surrounding environment and portray that environment tactilely. The system also includes sensor fusion algorithms for obstacle detection and localization, along with associated hardware. It should be noted that, although embodiments are described as they may be implemented with a smart phone, any other system or device that is similarly equipped in terms of sensors may be used instead, or separate sensors could be embedded in the device or operated in conjunction with the device.

In some implementations, a haptic display apparatus employs PCB (printed circuit-board)-based electric or magnetic actuator arrays and mechanical flexures to control the surface topography of the apparatus in real-time. For example, an array of magnetic dots with controllable magnetization strengths may trigger their corresponding miniature permanent magnets to deform a flexure. Also, or instead, electric motors could be used in conjunction with lead screws or cams to modify the heights of individual haptic dots, either directly or via deformable flexures. This allows dynamic modification of the topography of the surface of the apparatus by driving any desired subset of the dots.

The disclosed technology can benefit from the complete sensory suite onboard smart phones, including cameras, IMUs (inertial measurement units), GPS (global positioning system) and, most recently, LiDAR (light detection and ranging) technology. This significantly improves reliability and reduces the cost of the instrument. For example, addition of LiDAR to the latest models of smart phones increases the reliability of real-time obstacle detection to an unprecedented level. Although it may operate in conjunction with a portable electronic device (e.g., smart phone) in some embodiments, in other embodiments, a haptic display device or apparatus provided herein may also or instead be used as an accessory to a traditional tool of navigation (e.g., a white cane).

Advantages of the proposed apparatus and methods include: (1) compatibility with existing electronic devices such as smart phones, a technology that is already widely adopted by the visually impaired, and hence does not necessitate carriage of additional devices; (2) haptic interaction takes place as needed (e.g., on demand or continuous), meaning that the visually impaired can choose to use the haptic navigation system by activating it with a simple touch or deactivate or disregard it by simply ceasing physical contact with the apparatus; (3) utilization of the capability and training in interpreting fingertip tactile stimulation that most individuals with visual impairment already possess, due to prior experience with the Braille, thereby reducing the necessary adaptation and training; and (4) representation of receding obstacles (e.g., potholes) as well as protruding obstacles (e.g., cars) via the refreshable dotted pattern.

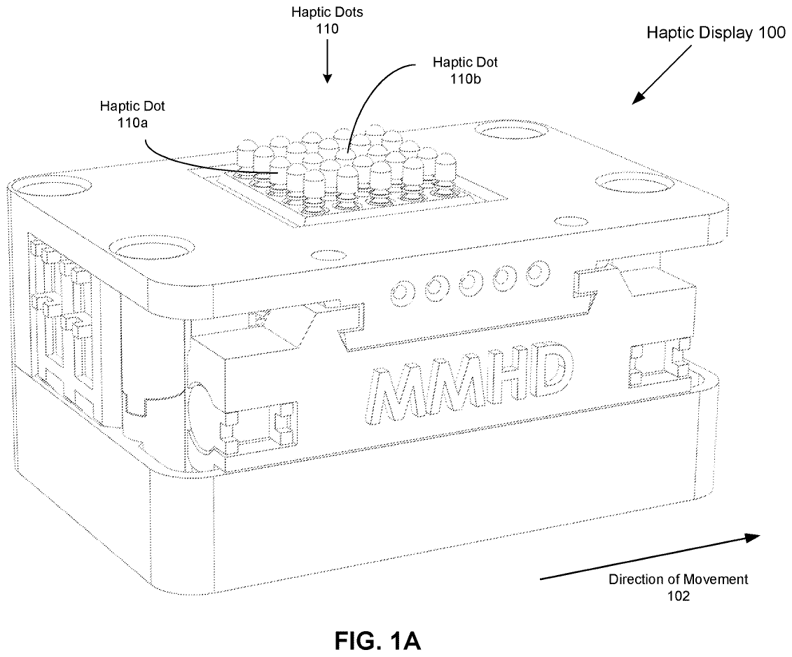

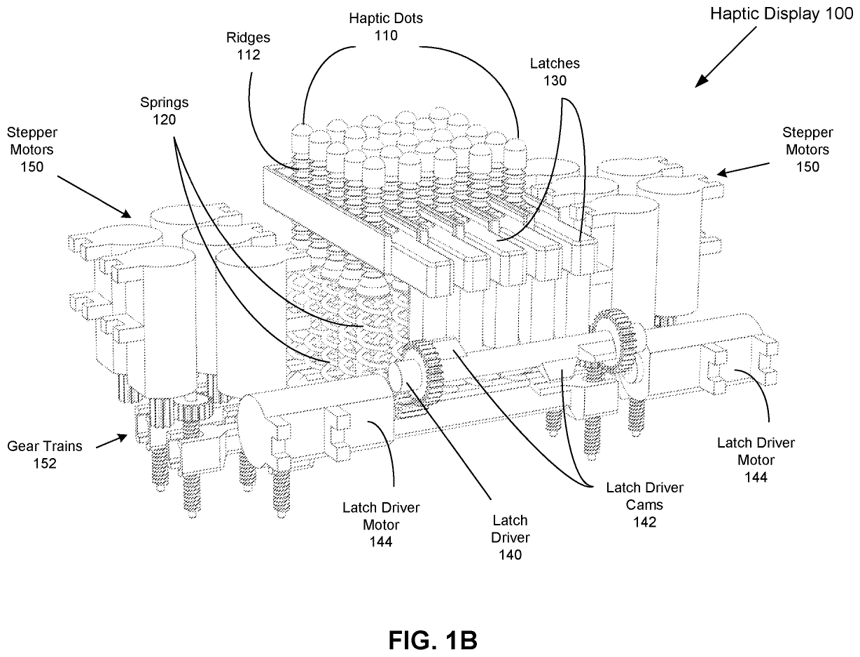

FIGS. 1A-B illustrate a mechanically multiplexed haptic display, according to some embodiments. FIG. 1A is a perspective view of a complete display device, while FIG. 1B is a perspective view of the interior of the device.

In FIG. 1A, haptic (or tactile) display 100 features a set of haptic dots 110, which may be arranged in a grid pattern in some embodiments, but in other patterns in other embodiments. Display 100 features a 5×5 grid of dots 110, but other implementations may employ any number of dots, including tens or hundreds. Actuators for raising/lowering dots 110 are configured to operate upon multiple dots, so that the dot-to-actuator ratio is greater than 1:1.

As shown in FIG. 1B, haptic dots 110 comprise knobs or nubs that a user touches, and springs 120 to assist in controlling the heights of the dots. Specifically, by compressing a spring 120 the corresponding dot 110 can be forced upward, and by applying tension it can be pulled downward further into device 100.

However, latches 130 serve to lock columns of dots into place, and applying a force to a spring 120 will cause the corresponding dot to be adjusted only if the dot is currently unlatched. When locked, a latch 130 engages ridges 112 of the latch's row of dots 110 to prevent the dots from being adjusted.

As shown in other figures and discussed below, lift bars below springs 120 work on individual rows of haptic dots 110. Thus, coordinating the lift bars and latches 130 allows every dot to be addressed and configured independently of other dots. The lift bars are controlled by stepper motors 150 and gear trains 152.

Latch driver 140 operates to individually unlock latches 130. Latches 130 may be biased (e.g., with springs not shown in FIGS. 1A-B) toward their locked positions, so that when the haptic display device is not being updated, the latches are locked and the haptic dots are stationary. However, when latch driver 140 is rotated, cams 142 operate upon latches 130 to open, unlatch, or unlock one latch at a time, for adjustment. Latch driver motors 144 cause the latch driver to rotate.

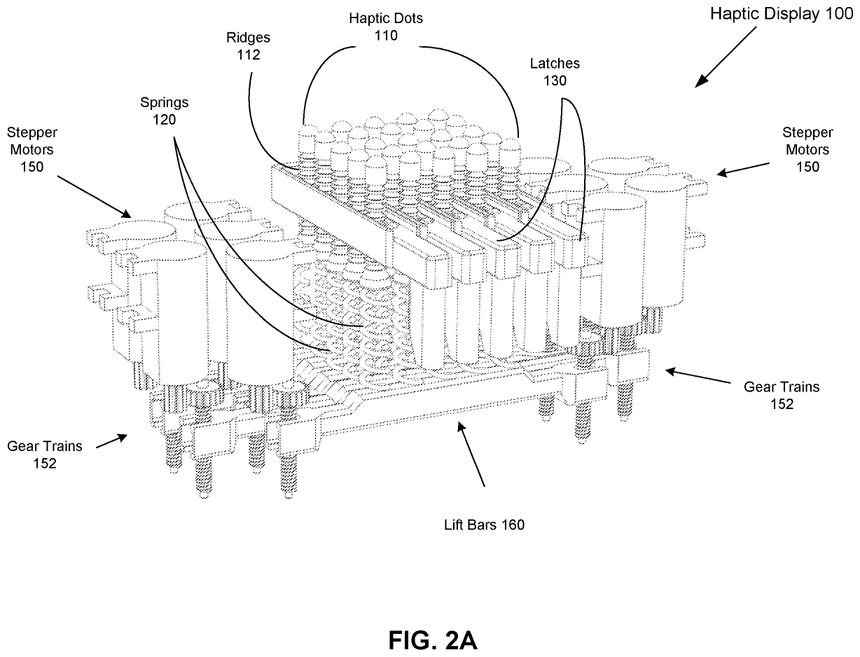

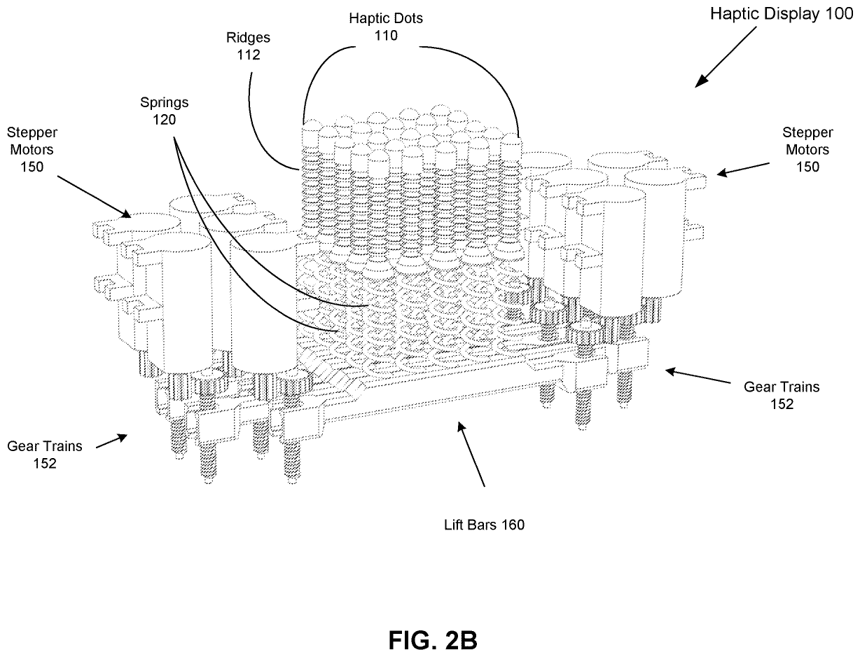

FIGS. 2A-B further illustrate haptic display 100, according to some embodiments. FIG. 2A omits latch driver 140 and associated components, while FIG. 2B omits latches 130, to show other detail not visible in FIGS. 1A-B.

In these figures, lift bars 160 are visible, each of which is coupled to and controlled by one pair of stepper motors 150. Specifically, by raising (or lowering) their lift bar 160, a cooperating pair of stepper motors 150 raise (or lower) all haptic dots 110 in a corresponding row of display 100 that are unlatched. Because only one column of dots is unlocked at a time in some embodiments, generally only one of the dots will be adjusted at a time. However, after it is adjusted, its dot column may then be latched, after which a different column may be unlatched and another dot in the same row can be adjusted based on the force applied to the lift bar by the pair of stepper motors.

In an illustrative implementation, stepper motors 150 are 4.3 mm in diameter, with gear train ratios of 2.25:1 (e.g., 8 teeth on the motor pinions and 18 teeth on the gears that translate action of the motors to motion of corresponding lift bars 160). In this implementation, latch driver motors 144 are also 4.3 mm in diameter but feature gear train ratios of 3:1 (e.g., 8 teeth on the motor pinions and 24 teeth on the latch driver gear). However, in other implementations, stepper and latch drive motors may be of other sizes and/or other gear ratios may be employed.

The number of ridges 112 of a haptic dot 110 may determine the discrete number of positions that a dot may assume, height wise. In some implementations, a normal or resting position of a dot (i.e., when no torsion or compression is applied to it) may correspond to level surface in the represented topography. Thus, when haptic display 100 is in use and is tactilely representing the user's surrounding area, each location in the area that is level with a surface on which the user is currently standing may be represented with a dot at it normal or resting position. Locations higher the surface level will be represented with dots higher or taller than the resting dots, and locations below the surface level (e.g., holes, depressions) will be represented with dots lower or shorter than the resting dots.

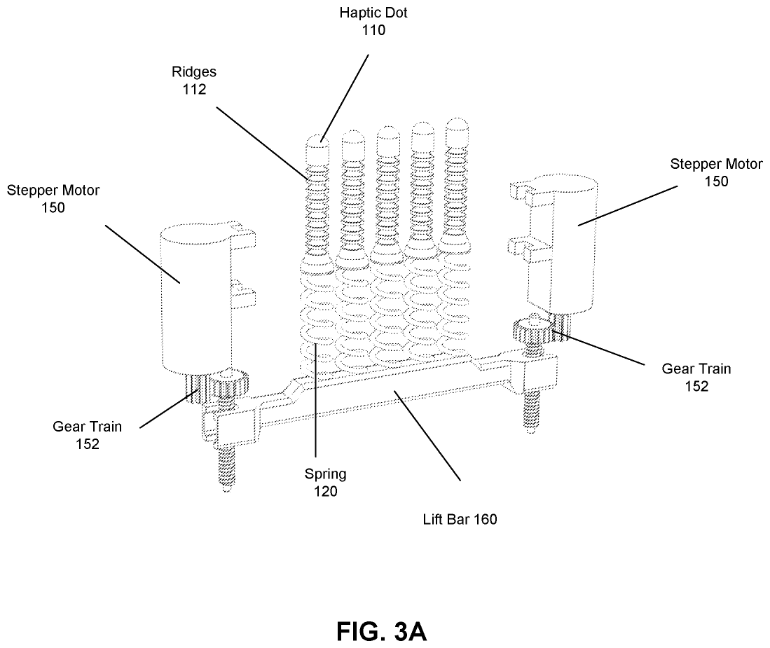

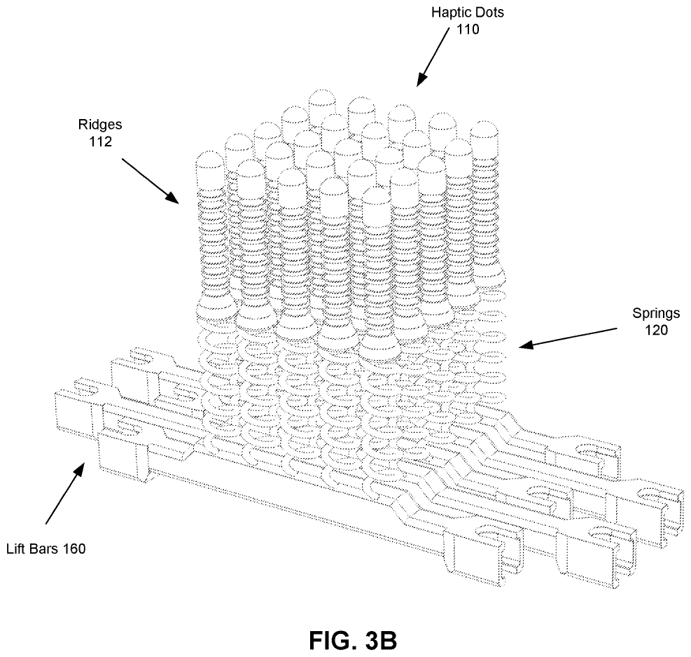

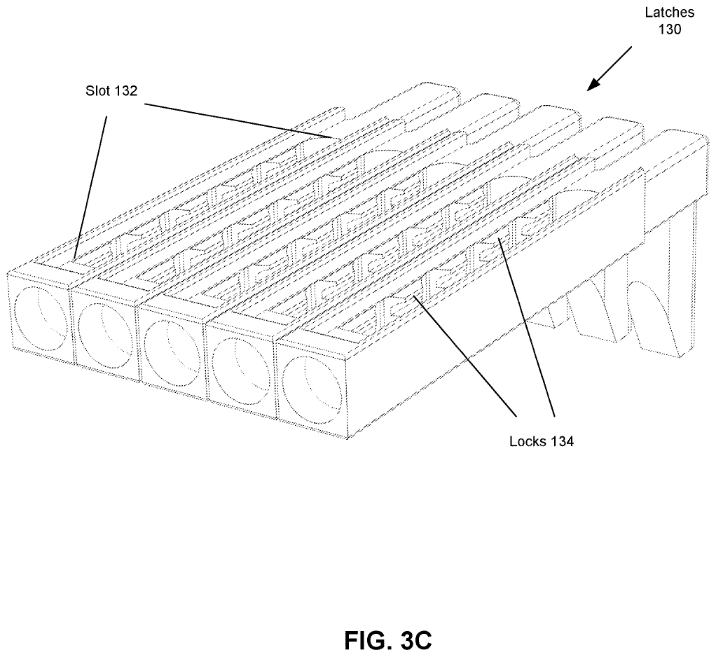

FIG. 3A illustrates a single lift bar with associated haptic dots, according to some embodiments. In these embodiments, lift bar 160 is connected to multiple haptic dots 110 (i.e., one row of dots) via their corresponding springs 120. Any of the attached dots that are unlatched when stepper motors 150 and gear trains 152 adjust lift bar 160 will be raised or lowered accordingly.

FIG. 3B illustrates an array of haptic dots that is formed by combining multiple lift bars, according to some embodiments. Although lift bars 160 are parallel, they may be of different lengths and their interfaces with stepper motors 150 may be offset (e.g., to conserve space).

FIG. 3C illustrates a set of latches for locking the array of haptic dots shown in FIG. 3B, according to some embodiments. As described previously, each latch is individually operated to unlock a corresponding column of haptic dots 110. More specifically, slot 132 in a latch 130 accommodates one column of dots. When the dots are latched, locks 134 engage ridges 112 of the dots to prevent them from transitioning upward or downward (e.g., along a z-axis of haptic display 100). When a latch is moved laterally to unlock its column of dots, the ridges of the dots are positioned between horizontally adjacent locks 134. Then, any dot in that column can be raised or lowered by adjusting the corresponding lift bar 160.

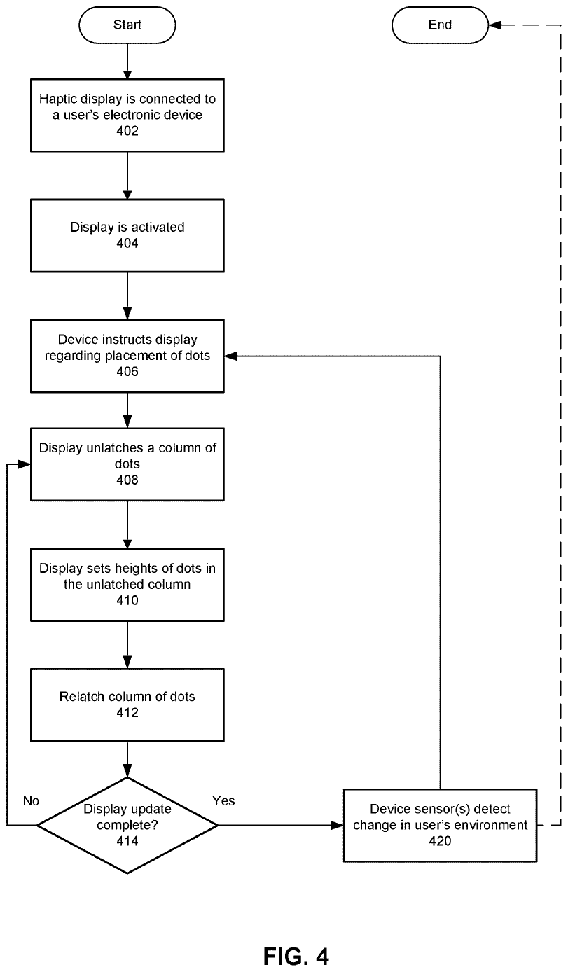

FIG. 4 is a flowchart demonstrating a method of operating a mechanically multiplexed haptic display, according to some embodiments. In other embodiments, one or more of the operations may be omitted, repeated, and/or performed in a different order. Accordingly, the specific arrangement of steps shown in FIG. 4 should not be construed as limiting the scope of the embodiments.

In operation 402, a user couples a tactile-enhanced (or haptic) display to an electronic device, such as a smartphone or a tablet. In different implementations, the connection may be wired or wireless in nature, and communication between the display and the device may involve a custom protocol designed for operating the display, or may involve an existing protocol (e.g., Bluetooth®, some other peer-to-peer protocol, a client/server protocol).

In the illustrated embodiments, the device executes an application for consuming the device's sensor data, translating that data as necessary, and sending instructions to the display to move the display's haptic dots to reproduce the physical environment portrayed by the data. Thus, the application may constantly or regularly generate data (e.g., bitmaps) or instructions for portraying map real-world obstacles using the display's haptic dots, such as by instructing the display to set the height of each dot to a specified height.

In operation 404, operation of the tactile-enhanced display commences automatically (e.g., when it connected to the device), when the user turns it on (e.g., with a button, switch, or other component), when the application opens, or in some other manner. The display may implement a start-up routine, to test operation of each haptic dot, to ensure it is receiving expected data from the electronic device, etc. It may signal the user when it is ready, via an audible tone and/or a haptic notification.

In operation 406, the display begins receiving (e.g., and acknowledging) instructions regarding how to configure or reconfigure its haptic dots to portray the user's surrounding environment. The device may, for example, send maps that identify the desired heights of each dot. A dot's height may be negative (i.e., the top of the dot is below the surface of the display), positive (i.e., the top of the dot is about the surface), or neutral (i.e., the top of the dot is substantially flush with the surface). Also, or alternatively, the device may send updates that comprise changes or deltas from a previous configuration. For example, if only a small subset of the dots needs to be adjusted from one moment to the next, the device may send instructions that identify just those dots and the heights they should be set to. The display may incorporate memory for storing the dots' positions/heights.

In some embodiments, and as indicated above, ground level in the user's physical environment may correspond to a surface of the haptic display, meaning that dots lower than the surface represent receding obstacles and dots above the surface represent protruding obstacles. In other embodiments, however, the surface of the haptic display may be lowest position a dot can take. In these embodiments, therefore, ground level may correspond to dot positions one or more ridges or segments above the surface of the display.

The dots may be numbered, identified, or labeled in any suitable manner, using sequential numbers (e.g., 0 to N−1 when the display features N haptic dots), matrix notation (e.g., with numerals identifying the column and row of each dot), etc. Depending on the number of dots, in different embodiments each one may represent a different amount of space in the user's surrounding environment (e.g., one square foot, one square meter). Thus, the greater the number of haptic dots, the greater resolution the display may provide, and the less physical area each dot may represent.

In an embodiment in which the display receives raw sensor data and is configured (e.g., with a processor and memory/storage) to process the data to generate dot-movement instructions (i.e., instead of simply receiving the instructions from the device), in operation 406 the display would begin receiving sensor data from the user's electronic device, particularly data that describes the physical environment around the user. In different implementations, different sensor data may be used. By orienting the device appropriately, a camera, LiDAR scanner, and/or other sensor may capture the environment in front of and/or to the side(s) of the user. Thus, in these embodiments, raw data describing the environment, especially distances to and dimensions of protruding and receding obstacles, are communicated to the display. The data may be filtered, at the device or the display, to focus upon obstacles within some distance of the user or device and up to some height above ground level, and the display may parse the data to map real-world obstacles to the display's array of haptic dots.

In operation 408, the haptic display begins or continues to recreate the user's environment as portrayed by the device's sensors. For example, assuming the application that is executing on the device sends a full mapping of dots and respective heights, the display unlatches one column of dots by moving a latch 130 (shown in FIG. 1) from its locked position. The unlatched dots will then naturally release any tension or compression in their supporting springs, based on the current height of their corresponding lift bars.

In operation 410, stepper motors 150 for each dot/row in the column are operated to move their associated lift bars to the specified heights for the row/dot. All lift bars may operate in unison or in sequence.

In operation 412, after each row/dot in the column is set to its assigned height, the latch is relatched and the column of dots is locked.

In operation 414, if the last column in the display has been updated and relatched, the method advances to operation 420. Otherwise, the method returns to operation 408 to unlatch the next column of haptic dots for adjustment.

In operation 420, the device's sensors detect a change in the environment, which may be caused by the user moving (e.g., walking, turning) and/or a moving obstacle (e.g., a pedestrian, a vehicle) entering sensor range. Therefore, the method returns to operation 406 so the display application can send new dot-adjustment instructions to the display.

When the user turns off the haptic display, terminates the display application, shuts off the device, ceases holding the display, or takes some other predetermined action, the display turns off or otherwise stops operating, and the method ends. This may cause the display to remain in its last programmed configuration, or the display may set all dots to prespecified or neutral positions (i.e., with no tension or compression) before turning off.

In embodiments in which haptic dots of the display are ridged, as shown in FIGS. 1A-B for example, when a dot is adjusted then latched, one of the dot's ridges is engaged by the latch. The number of ridges therefore determines the maximum negative and positive displacements of the dot, which correspond to how far below the surface of the display and how far above the surface the top of the dot can be placed. In different implementations, these maximums may vary.

In an exemplary implementation, a dot may be able to be displaced no more than one or two ridges below the surface. In this implementation, displacing a dot one ridge below the surface may correspond to a real-world receding obstacle that is no more than a predetermined depth (e.g., four inches), while displacement more than one ridge below the surface may indicate any depth greater than the predetermined depth, which may indicate to the user that the corresponding area of his or her currently location should be avoided. Of course, in other implementations, the range of negative displacements may be greater, to represent a flight of stairs for example.

A larger range of positive displacement may be allowed for by enabling the haptic dot to rise a few or several ridges above the surface of the display. Each offset from one ridge to another may be equal in magnitude with respect to what it portrays in the user's environment (e.g., each ridge corresponds to two feet of height of a protruding obstacle), or there may be a geometric or logarithmic progression. For example, a dot that is one ridge above the surface may indicate a protruding obstacle that is no more than one foot high, a dot that is two ridges above the surface may indicate an obstacle that is no more than two feet high, a dot that is three ridges above the surface may indicate an obstacle that is no more than six feet high, and so on, with the maximum positive displacement representing infinity or other insurmountable protruding obstacle.

In some embodiments, an application for operating a haptic display maps sensor data to the display's dots in a proportional manner. For example, if the device's sensors provide a 180° view of the user's surroundings, centered straight ahead of the user/device, the user's current location may be mapped to one specific dot, such as dot 110a or dot 110b (shown in FIG. 1A), assuming the user and display are facing the indicated direction of movement 102.

When the user's location is mapped to dot 110a, remaining dots 110 of display 100 represent the environment ahead of and to either side of the user and may provide a first fixed resolution (e.g., one square foot per dot), or dots closer to dot 110a may represent smaller areas than dots further away, to better guide the user in his or her immediate vicinity. When the user's location is mapped to dot 110b, the remaining dots represent the environment surrounding the user (including behind him or her) and may provide a second resolution similar to or different than the first resolution and may, again, have fixed ratios with respect to the real-world areas they represent, or closer dots may represent smaller areas than dots further away.

Instead of using stepper motors and gear trains to drive lift bars to raise/lower haptic dots via helical springs, other means nay employed to raise and lower the dots.

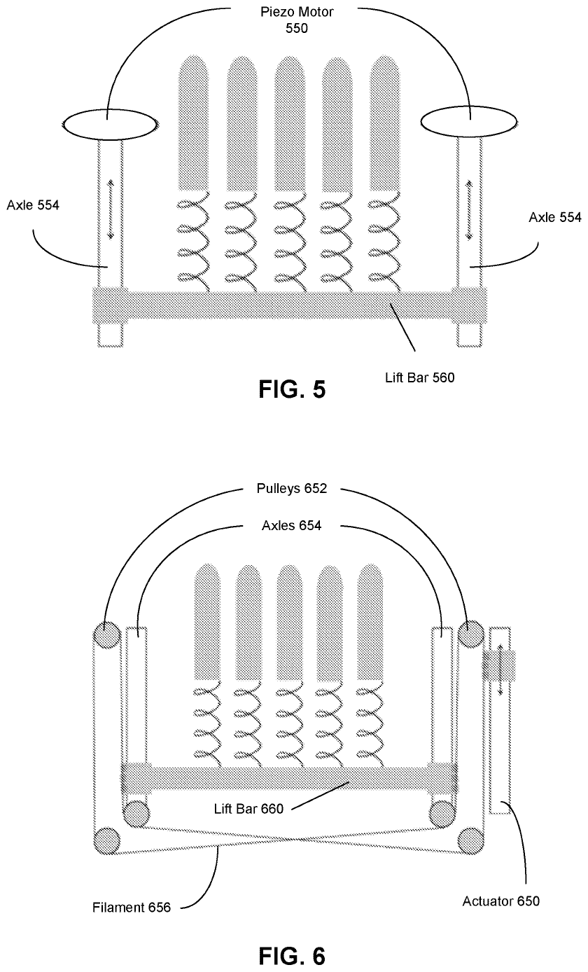

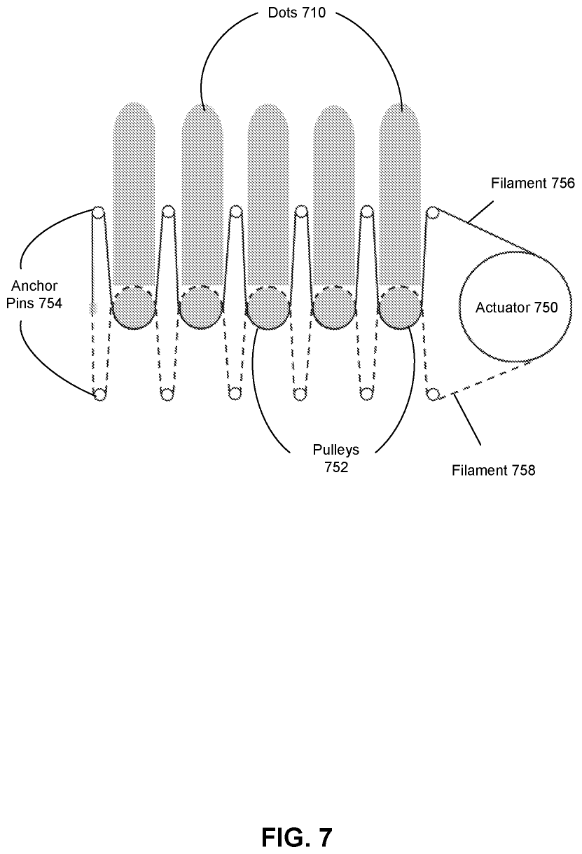

FIGS. 5-7 illustrate alternative apparatus for adjusting haptic dots of a tactile-enhanced display, according to some embodiments. In FIG. 5, piezo linear actuators are employed to convert electricity directly into linear motion using the piezoelectric effect. Specifically, piezo motors 550 engage axles 554 to raise and lower lift bar 560 due to mechanical force imparted by the piezo motors in response to applied voltages. In FIG. 6, one or more (linear) actuators 650 adjust a thread, wire, or other filament 656 that is attached to lift bar 660 via pulleys 652. Movement of the filament in one direction raises the lift bar along axles 654, while movement in the other direction lowers it. In FIG. 7, one or more (rotational) actuators drive two filaments 756, 758 threaded around anchor pins 754 and pulleys 752, which are connected to haptic dots 710. Rotation of actuator 750 in one direction raises the dots, while rotation in the other direction lowers them.

In some embodiments, a haptic display tactilely depicts a picture, painting, or other visual image. In these embodiments, the display receives a set of instructions for configuring the display's dots, or receives raw data describing the image that it then converts into such instructions. For example, the instructions may map the dots to portions of the image (e.g., like a bitmap or a set of vectors) so that the dots are set to heights that indicate contours of the image (e.g., if it is an image of landscape), colors (e.g., so that all dots corresponding to same-colored area of the image are set to the same or similar height), brightness (e.g., for a black and white image), etc.

An environment in which one or more embodiments described above are executed may incorporate a general-purpose computer or a special-purpose device such as a hand-held computer, a smartphone, or other communication or computing device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A haptic display apparatus comprising:
a plurality of vertically adjustable elements for depicting a physical environment near a user of the apparatus; and
multiple mechanisms for vertically adjusting the elements.

2. The apparatus of claim 1, wherein:
each element comprises a top; and
the tops of the plurality of elements depict the physical environment near the user.

3. The apparatus of claim 2, wherein:
each element whose top is above a surface of the apparatus depicts a protruding obstacle in the physical environment; and
each element whose top is below a surface of the apparatus depicts a receding obstacle in the physical environment.

4. The apparatus of claim 3, wherein:
the height of the top of an element depicting a protruding obstacle is proportional to the height of the protruding obstacle; and
the depth of the top of an element depicting a receding obstacle is proportional to the depth of the receding obstacle.

5. The apparatus of claim 1, wherein:
each element comprises multiple segments; and
the number of segments of an element corresponds to the number of different altitudes to which the element may be vertically adjusted.

6. The apparatus of claim 1, wherein:
the multiple mechanisms comprise lift bars; and
each lift bar is connected to multiple elements.

7. The apparatus of claim 6, wherein each lift bar is connected to one row of elements.

8. The apparatus of claim 6, wherein each of the elements is connected to a lift bar with a helical spring.

9. The apparatus of claim 6, further comprising multiple actuators for raising and/or lowering the lift bars.

10. The apparatus of claim 6, wherein the multiple actuators include one or more of:
a pair of stepper motors connected to associated gear trains coupled to a first lift bar;
a pair of piezo linear actuators connected to axles coupled to a second lift bar; and
a linear actuator connected to a filament coupled to a third lift bar.

11. The apparatus of claim 1, further comprising:
a set of latches for latching the elements.

12. The apparatus of claim 11, wherein each latch in the set of latches is operable to latch or unlatch a subset of the elements.

13. The apparatus of claim 11, further comprising a latch driver that selectively operates a latch to unlatch and/or to latch a corresponding subset of the elements.

14. The apparatus of claim 11, further comprising a latch driver that selectively operates a latch to unlatch and/or to latch one column of the elements.

15. The apparatus of claim 1, further comprising:
an interface to an electronic device operated by the user;
wherein the electronic device executes an application that transmit instructions to the apparatus to vertically adjust the elements as the physical environment changes.

16. The apparatus of claim 1, further comprising:
one or more processors;
memory storing instructions for vertically adjusting the elements; and
an interface to an electronic device operated by the user;
wherein the apparatus receives sensor data from of the electronic device and generates instructions to vertically adjust the elements as the physical environment changes.

17. The apparatus of claim 16, wherein the sensor data is from one or more of:
an inertial measurement unit;
a light detection and ranging (LiDAR) component;
a camera;
radar; and
a global-positioning satellite (GPS) receiver.

18. The apparatus of claim 1, wherein the multiple mechanisms comprise multiple pulleys and one or more filaments.

19. A method comprising:
at a haptic display, obtaining information describing a physical environment, wherein the haptic display comprises a plurality of haptic dots; and
adjusting a plurality of haptic dots of the haptic display to represent the physical environment for tactile interpretation.

20. The method of claim 19, wherein:
said obtaining comprises receiving instructions, from an electronic device, for configuring the plurality of haptic dots;
the electronic device comprises one or more of:
an inertial measurement unit;
a light detection and ranging (LiDAR) component;
a camera;
radar; and
a global-positioning satellite (GPS) receiver; and
the electronic device executes an application for communicating with the haptic display.

21. The method of claim 19, wherein said obtaining comprises:
receiving, from an electronic device, sensor data for configuring the plurality of haptic dots; and
from the sensor data, determining a target configuration of the plurality of haptic dots;
wherein the electronic device comprises one or more of:
an inertial measurement unit;
a light detection and ranging (LiDAR) component;
a camera;
radar; and
a global-positioning satellite (GPS) receiver.

22. The method of claim 19, wherein adjusting the haptic dots comprises:
unlocking a subset of the haptic dots;
setting a height of each haptic dot in the subset to represent a portion of the physical environment;
locking the subset of haptic dots; and
repeating said unlocking, setting, and locking until the haptic dots represent the physical environment.

23. The method of claim 22, wherein unlocking a subset of the haptic dots comprises unlatching a first column of the haptic dots.

24. The method of claim 23, wherein unlatching the first column of haptic dots comprises operating a latch driver to move a first latch from a locked position to an unlocked position, thereby allowing each haptic dot in the first column to be vertically adjusted.

25. The method of claim 23, wherein setting a height of each haptic dot comprises:
raising or lowering each haptic dot in the first column to represent an area of the physical environment;
wherein a protruding obstacle in the area causes a top of a corresponding haptic dot to be positioned above a surface of the haptic display; and
wherein a receding obstacle in the area causes a top of a corresponding haptic dot to be positioned below the surface.

26. The method of claim 25, wherein raising or lowering a haptic dot comprises adjust a corresponding lift bar coupled to the haptic dot via a helical spring.

27. The method of claim 26, wherein adjusting a lift bar comprises operating one of:
a pair of stepper motors connected to associated gear trains coupled to a first lift bar;
a pair of piezo linear actuators connected to axles coupled to a second lift bar; and
a linear actuator connected to a filament coupled to a third lift bar.

28. The method of claim 25, wherein locking the subset of haptic dots comprise relatching the first column of haptic dots to lock them in position.

29. The method of claim 19, further comprising:
coupling the haptic display to a portable electronic device; and
executing, on the device, an application that converts sensor data regarding the physical environment into instructions for adjusting the plurality of haptic dots.

30. The method of claim 29, wherein said converting comprises:
identifying one or more obstacles in the physical environment;
mapping locations of the obstacles to corresponding haptic dots of the haptic display; and
instructing the display to modify the corresponding haptic dots to represent the one or more obstacles.

31. A system for tactilely representing a physical environment, the system comprising:
a portable electronic device having one or more sensors for sensing the physical environment;
a haptic-enabled accessory having a deformable surface; and
memory storing instructions for execution by a processor that, when executed, cause the deformable surface to represent one or more obstacles detected within the physical environment.
